(19) United States
(12) Patent Application Publication
(10) Pub. No.: US 2009/0050094 A1
(43) Pub. Date: Feb. 26, 2009

(54) INTAKE CONTROL DEVICE FOR INTERNAL COMBUSTION ENGINE

(75) Inventor: Ryo SANO, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/196,541

(22) Filed: Aug. 22, 2008

(30) Foreign Application Priority Data
Aug. 24, 2007 (JP) 2007-217842

(51) Int. Cl. F02M 35/10

(52) U.S. Cl. 123/184.21

(57) ABSTRACT

An intake control device for an internal combustion engine includes an intake air induction duct, a housing, a valve, and a slope member. The intake air induction duct includes a bonding surface that is bonded with an attachment surface of the internal combustion engine, and the intake air induction duct defines therein a receiving chamber that opens at the bonding surface. The housing is received in the receiving chamber, and the housing defines therein an intake passage that is communicated with an intake port of the internal combustion engine. The valve is received in the housing for opening and closing the intake passage. The slope member cancels a step provided between the intake port and the intake passage.

### CROSS REFERENCE TO RELATED APPLICATION

This application is based on and incorporates herein by reference Japanese Patent Application No. 2007-217842 filed on Aug. 24, 2007.

### BACKGROUND OF THE INVENTION

1. Field of the Invention

The present invention relates to an intake control device for an internal combustion engine, which device includes, for example, a valve unit or an intake passage opening and closing device.

2. Description of Related Art

Conventionally, as shown in FIG. 3, there has been proposed an intake control device for an internal combustion engine, which device includes a valve unit that is received in a receiving chamber 104 of an intake manifold 103 connected with an intake manifold attachment surface of a cylinder head 101 of the internal combustion engine (see, for example, JP-A-2007-040282). The valve unit includes a housing 105 and a valve 106. Specifically, the housing 105 is assembled in the receiving chamber 104 of the intake manifold 103, and the valve 106 opens and closes an interior of the intake manifold 103. In other words, the valve 105 opens and closes first and second intake passages 111, 112 that are communicated with an intake port 110 of the internal combustion engine.

Also, the valve unit employs a cantilever valve as the valve 106. The cantilever valve has a rotational shaft 107 that is displaced from a center section of the valve toward one end of the valve. The above configuration is made such that intake air resistance of intake air that flows in the intake manifold 103 or in the first and second intake passages 111, 112 is reduced in a case, where the valve 108 is located at a fully-opened position for fully opening the passage 112. In the above configuration, the rotational shaft 107 serves as a rotation center, about which the valve 106 rotate. The housing 105 is provided with a valve accommodation space 113 that is provided at a lower part of the second intake passage 112 in a gravitational force direction (vertical direction) for accommodating the valve 108 when the valve 106 is located at the fully-opened position for fully opening the second intake passage 112.

However, as shown in FIG. 3 in a structure (intake passage structure of the internal combustion engine), where a rotational shaft 107 of the valve 106 is received in a valve accommodation space 113 of the housing 105, a step 114 is formed between a lower surface of the intake port 110 of the cylinder head 101 in the gravitational force direction and a lower surface of the second intake passage 112 of the housing 105 in the gravitational force direction. As a result, a blowback or a backward flow may cause fuel to fall into a lower part 115 of the second intake passage 112 (the valve accommodation space 113) of the housing 105 in the gravitational force direction, and the fuel may stay and be accumulated in the lower part 115 disadvantageously.

Then, the fuel, which stays in the lower part 115 of the housing 105, may get over the step 114 due to the sharp increase of the intake air amount or due to the engine vibration, and thereby a large amount of the accumulated fuel may flow into the combustion chamber of the internal combustion engine at one stroke. In the above case, an air-fuel ratio in the combustion chamber of the internal combustion engine may become considerably richer or excessively richer, and thereby incomplete combustion may occur. Thus, an exhaust gas purification performance or an emission may deteriorate disadvantageously.

### SUMMARY OF THE INVENTION

The present invention is made in view of the above disadvantages. Thus, it is an objective of the present invention to address at least one of the above disadvantages.

To achieve the objective of the present invention, there is provided an intake control device for an internal combustion engine, which device includes an intake air induction duct, a housing, a valve, and a slope member. The intake air induction duct includes a bonding surface that is bonded with an attachment surface of the internal combustion engine, and the intake air induction duct defines therein a receiving chamber that opens at the bonding surface. The housing is received in the receiving chamber of the intake air induction duct, and the housing defines therein an intake passage that is communicated with an intake port of the internal combustion engine. The valve is received in the housing for opening and closing the intake passage of the housing. The slope member cancels a step provided between the intake port of the internal combustion engine and the intake passage of the housing.

To achieve the objective of the present invention, there is also provided an intake control device for an internal combustion engine having an intake port and an attachment surface, the intake control device including an intake air induction duct, a housing, a valve, and a slope member. The intake air induction duct includes a bonding surface that is bonded with the attachment surface of the internal combustion engine, and the intake air induction duct defines therein a receiving chamber that opens at the bonding surface. The housing is received in the receiving chamber of the intake air induction duct, and the housing defines therein an intake passage that is communicated with the intake port of the internal combustion engine. The valve is received in the housing for opening and closing the intake passage of the housing. The slope member is provided in the intake passage of the housing for gradually reducing a vertical dimension of the intake passage as a function of a position of the intake passage in an intake air flow direction, and the vertical dimension of the intake passage is measured generally vertically between opposing inner surfaces of the intake passage. The slope member is provided at a position to define a bypass passage between the slope member and the valve, and the bypass passage allows intake air to flow around the valve when the valve is located at a fully-closed position for closing the intake passage.

### BRIEF DESCRIPTION OF THE DRAWINGS

The invention, together with additional objectives features and advantages thereof, will be best understood from the following description, the appended claims and the accompanying drawings in which:

FIG. 1A is a cross-sectional view of an intake control device for an internal combustion engine taken along line IA-IA in FIG. 1B according to a first embodiment of the present invention;

FIG. 18 is a schematic drawing showing the intake control device for the internal combustion engine;

FIG. 2A is a cross-sectional view of an intake control device for an internal combustion engine taken along line IIA-IIA in FIG. 2B according to a second embodiment of the present invention;

FIG. 2B is a schematic drawing showing the intake control device of the internal combustion engine; and

FIG. 3 is a cross-sectional view showing a conventional intake control device for an internal combustion engine.

### DETAILED DESCRIPTION OF PREFERRED EMBODIMENTS

### First Embodiment

### Configuration of First Embodiment

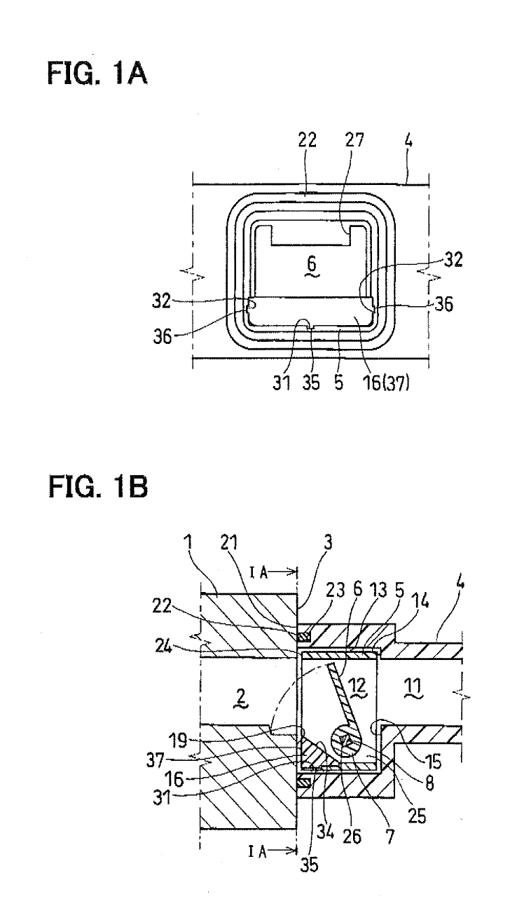

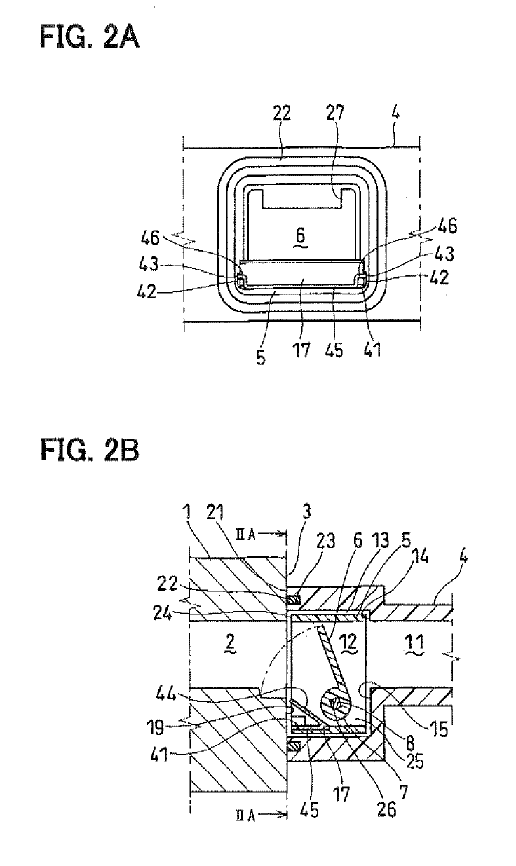

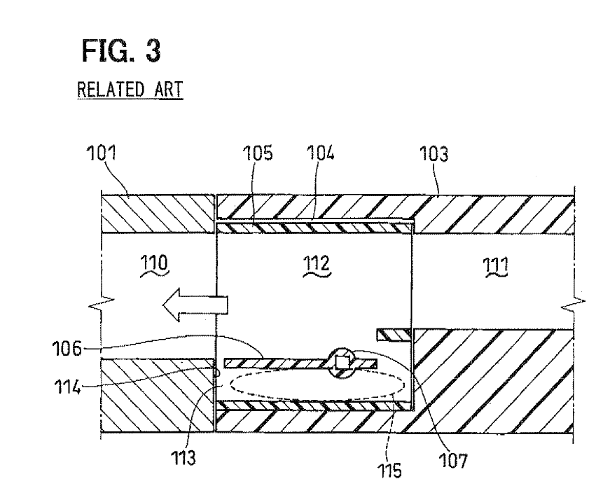

FIG. 1A is a diagram illustrating a valve unit (cartridge) according to a first embodiment of the present invention, and FIG. 1B is a drawing illustrating an intake control device for an internal combustion engine.

The intake control device for the internal combustion engine of the present embodiment includes an intake passage opening/closing device (throttle control device) and an intake air vortex flow generator (intake air module). The intake passage opening/closing device opens and closes an intake air induction passage (intake passage to the internal combustion engine), which supplies auctioned air (intake air) to a combustion chamber for each cylinder of the internal combustion engine (for example, four-cylinder gasoline engine, which is referred as an engine hereinafter). The intake air vortex flow generator generates an intake air vortex flow in order to facilitate combustion of an air-fuel mixture in each cylinder of the engine.

In the above configuration, the engine generates an output caused by thermal energy obtained by causing the combustion of the air-fuel mixture, which includes intake air and fuel, in the combustion chamber. The engine employs a four-cycle engine, in which four strokes, such as an intake stroke, a compression stroke an expansion (combustion) stroke, and an exhaust stroke, are cyclically repeated. For example, the engine is mounted in an engine room of a vehicle, such as an automobile. The engine includes an intake pipe (intake duct) and an exhaust pipe (exhaust duct). The intake pipe introduces intake air to the combustion chamber of the engine, and the exhaust pipe discharges exhaust gas flowing out of the combustion chamber of the engine to an exterior via an exhaust gas purifying device.

The engine includes a cylinder block (not shown) and a cylinder head 1. The cylinder block defines a cylinder bore therein, and the cylinder head 1 is mounted on a head attachment surface of the cylinder block via a metal gasket.

A piston is received in the cylinder bore of the cylinder block for being slidable in a center axial direction of the cylinder bore. The piston is connected with a crank shaft via a connecting rod.

The cylinder head 1 has intake ports 2 on one end of the cylinder head 1, and each of the intake ports 2 is opened and closed by a poppet intake valve. Also, the cylinder head 1 has exhaust ports on the other end of the cylinder head 1, and each exhaust port is opened and closed by a poppet exhaust valve.

The cylinder head 1 is provided with spark plugs (not shown) such that each of the spark plugs has an end portion exposed to the combustion chamber of each cylinder. Also, the cylinder head 1 is provided with an injector (an internal combustion engine fuel injection valve, an electromagnetic fuel injection valve, which are not shown), and the injector injects fuel in the intake port 2 of each cylinder of the engine at optimal timing.

Also, the cylinder head 1 is integrally provided with multiple bonding portions on the upstream end portion of the cylinder head 1 in the intake air flow direction toward the intake manifold, and each of the bonding portions has an intake manifold attachment surface 3 (an attachment surface of the internal combustion engine). The multiple intake ports 2 defined in the cylinder head 1 open at the intake manifold attachment surfaces 3 of the cylinder head 1. Also, each bonding portion of the cylinder head 1 is integral with a flange portion that has multiple bolt holes, through which fastening bolts extend.

The intake pipe of the engine serves as a casing for supplying intake air into the combustion chamber of each cylinder of the engine, and the intake pipe includes an air cleaner case, a throttle body, a surge tank, and an intake manifold 4 (intake air induction duct). The air cleaner case receives and supports an air cleaner (filtration element) that filters intake air. The throttle body is located downstream of the air cleaner case in the direction of the intake air flow (intake air flow direction) and is connected with the air cleaner case. The surge tank is located downstream of the throttle body in the intake air flow direction and is connected with the throttle body. The intake manifold 4 (intake air induction duct) has a double tube structure, and is located downstream of the surge tank in the intake air flow direction to be connected with the surge tank.

In the above, the throttle control device of the present embodiment controls a flow of intake air supplied to the combustion chamber of each cylinder of the engine in accordance with a throttle opening degree, which corresponds to a valve opening degree of the throttle valve.

The throttle control device includes the throttle body, a butterfly throttle valve, and a return spring. The throttle body is provided in the intake pipe of the engine, and the butterfly throttle valve changes an amount of intake air that flows inside the intake pipe (intake passage). The return spring or a default spring biases the throttle valve in a valve closing direction or in a valve opening direction.

Also, the throttle body includes an actuator having an electric motor that drives a rotational shaft, which supports the throttle valve in a fixed relation, in the valve opening direction or in the valve closing direction. As above, the throttle valve rotates about the rotational shaft.

In the above configuration, the electric motor that drives the throttle valve is energized and controlled by an engine control unit (engine control device referred as an ECU).

Similar to the engine, the intake air vortex flow generator of the present embodiment is mounted in the engine room of the vehicle, such as the automobile. The intake air vortex flow generator generates an intake air vortex flow in the axial direction (tumble flow) in order to facilitate or enhance the combustion of the air-fuel mixture in the combustion chamber of each cylinder of the engine.

The intake air vortex flow generator is assembled into an intake system of the engine together with the throttle control device. Also, the intake air vortex flow generator is a multiple integral intake passage opening/closing device (valve opening and closing device), which includes multiple valve units or multiple tumble flow control valves (TCVs) assembled as a one-piece construction in the intake manifold 4. Specifically, the multiple valve units are parallelly spaced from each other in the axial direction of a pin rod 8 (shaft) or along the rotational axis of the pin rod 8 by predetermined intervals in the intake manifold 4 (housing receiving chambers).

The intake air vortex flow generator includes the intake manifold 4, the multiple valve units, an actuator, and an EGU. The intake manifold 4 is air-tightly connected downstream of the throttle body of the intake pipe of the engine in the intake air flow direction. Each of the multiple valve units (TCVs) generates the tumble flow in the combustion chamber by controlling the intake air in the intake manifold 4 or the intake air that flows through first and second intake passages 11, 12, which communicate with the intake port 2 of the engine. The actuator includes an electric motor that drives the pin rod 8, which is press fitted with a rotational shaft 7 of an intake air flow control valve 6. In the above, the intake air flow control valve 6 serves as a valve element of the TCV. The ECU controls the valve opening degree of the TCV in association with each system of the throttle control device.

Each valve unit (TCV) of the present embodiment includes a housing 5 and the intake air flow control valve 6. The housing 5 is received in the housing receiving chamber 13 of the intake manifold 4, and the intake air flow control valve 6 is received in the housing 5 or in the second intake passage 12 of the housing 5 for opening and closing the second intake passage 12. It should be noted that the housing 5 and the intake air flow control valve 6 constitutes a valve unit (cartridge) that is fitted inside each housing receiving chamber 13 of the intake manifold 4.

The intake manifold 4 of the present embodiment is integrally molded of a resin material to have a predetermined shape, for example. The intake manifold 4 has multiple polygonal tubular portions, each of which is configured to surround the valve unit, or more specifically, to surround a periphery of the housing 5. Each of the polygonal tubular portions constitutes an outer polygonal tubular portion of the intake manifold 4 having the double tube structure.

There are defined the first intake passages 11 (intake passage to the internal combustion engine) inside the intake manifold 4. Each first intake passage 11 has a cross section of a square shape or of a rectangular shape. Each first intake passage 11 is independently connected with the intake port 2 of each cylinder of the engine via a corresponding second intake passage 12.

The intake manifold 4 includes the housing receiving chamber 13 at a position downstream of the first intake passage 11 in the intake air flow direction, and the housing receiving chamber 13 has a cross section of a square shape or of a rectangular shape. Each housing receiving chamber 13 serves as a valve unit receiving portion (valve unit receiving space) which receives a corresponding one of the multiple valve units (cartridge). Also, the housing receiving chamber 13 has a cross-sectional area of the opening, which area is greater than a cross-sectional area of the first intake passage 11.

Also, the intake manifold 4 includes a step 14 on an upper portion side of the intake manifold 4 in the gravitational force direction, the step 14 being provided between (a) an upper surface of the first intake passage 11 in the gravitational force direction and (b) an upper surface of the housing receiving chamber 13 in the gravitational force direction. In other words, the step 14 is provided between a ceiling surface of the first intake passage 11 and a ceiling surface of the housing receiving chamber 13.

Also, intake manifold 4 includes a step 15 at a lower part side of the intake manifold 4 in the gravitational force direction, the step 15 being provided between (a) a lower surface of the first intake passage 11 in the gravitational force direction and (b) a lower surface of the housing receiving chamber 13 in the gravitational force direction. In other words, the step 15 is provided between (a) a bottom surface of the first intake passage 11 and (b) a bottom surface of the housing receiving chamber 13.

The intake manifold 4 is integrally provided with a bonding portion that includes a bonding surface 21 on a downstream end portion of the intake manifold 4 in the intake air flow direction toward the cylinder head 1. The bonding portion is air-tightly bonded with the intake manifold attachment surface 3 of the cylinder head 1.

The multiple housing receiving chambers 13 defined inside the intake manifold 4 open at the corresponding bonding surfaces 21 of the intake manifold 4. Then, each bonding surface 21 of the intake manifold 4 is provided with a fitting groove 23 that is to be fitted with a gasket 22. In the above, the fitting groove 23 has a square annular shape or a rectangular annular shape, and the gasket 22 has a square annular shape or a rectangular annular shape correspondingly. Also, the bonding portion of the intake manifold 4 is integrally provided with a flange portion having multiple screw holes, into which fastening bolts are screwed.

The intake manifold 4 is fastened to and is bonded with the intake manifold attachment surface 3 of the cylinder head 1 by using multiple fastening bolts in a condition, where the bonding surface 21 of the intake manifold 4 tightly contact the intake manifold attachment surface 3 of the cylinder head 1.

The housing 5 of each of the multiple valve units is integrally molded of a resin material to have a predetermined shape, for example. Each of the multiple housings 5 is a polygonal tube having a polygonal tubular shape for receiving the intake air flow control valve 6 therein such that the intake air flow control valve 6 opens and closes the second intake passage 12. Also, each housing 5 constitutes an inner polygonal tubular portion of the double tube structure of the intake manifold 4. The housings 5 defines second intake passages 12 (intake passage to the internal combustion engine) therein, and each of the second intake passages 12 has a cross section of a square shape or of a rectangular shape.

Each of the multiple housings 5 includes a pair of opposing wall portions at both ends of each second intake passage 12 in a direction orthogonal to the axial direction (intake air flow direction) of the second intake passage 12. In the above, the above orthogonal direction may be defined as a horizontal direction that is perpendicular to a gravitational force direction of the second intake passage 12. Also, the opposing wall portions may be both side wall portions or left-right side wall portions, and are referred as housing left-right wall portions. Also, each of the multiple housings 5 includes a pair of up-down wall portions at both ends of each second intake passage 12 in the other orthogonal direction orthogonal to the axial direction (intake air flow direction) of the second intake passage 12. In the above, the other orthogonal direction corresponds to the gravitational force direction (vertical direction) of the second intake passage 12. The up-down wall portions include a top wall portion and a bottom wall portion, and are referred as housing up-down wall portions.

The second intake passage 12 of each of the multiple housings 5 opens at an upstream end of the housing 5 in the axial direction (intake air flow direction), and the upstream end of the housing 5 serves as an intake air introduction port (inlet portion) for inducting intake air into the second intake passage 12 from the corresponding one of the first intake passages 11 of the intake manifold 4.

Also, the second intake passage 12 of each of the multiple housings 5 opens at a downstream end of the housing 5 in the axial direction (intake air flow direction), and the downstream end of the housing 5 serves as an intake air delivering port (outlet portion) for delivering intake air into each intake port 2 of the cylinder head 1 from the corresponding second intake passage 12.

Also, each of the multiple housings 5 has an annular end surface 24 at a downstream side of the housing 5 in the intake air flow direction. The annular end surface 24 faces the intake manifold attachment surface 3 of the cylinder head 1 and is spaced from the attachment surface 3 by a predetermined clearance.

Each of the multiple housings 5 includes a valve accommodation space 25 at a lower side of the respective second intake passage 12 in the gravitational force direction. In other words, each housing 5 includes the valve accommodation space 25 near an under surface of the second intake passage 12 in the gravitational force direction or near a bottom surface of the second intake passage 12. The above valve accommodation space 25 is configured to accommodate or receive the intake air flow control valve 6 during the valve fully-opening state for fully opening the second passage 12 such that the intake air flow control valve 6 is limited from projecting in a main passage of the second intake passage 12.

In the above, the main passage of the second intake passage 12 is defined between (a) a valve surface of the intake air flow control valve 6 and (b) the housing upper wall portion of the housing 5 during the valve fully-opening state Note that the valve surface of the intake air flow control valve 6 corresponds to a flat surface among the two opposite surfaces of the control valve B. The main passage of the second intake passage 12 is, in other words, a space defined in the second intake passage 12 above the valve accommodation space 25 in the gravitational force direction or along the vertical axis, and the main passage has the same opening area, which is generally identical with the area of the first intake passage 11 of the intake manifold 4 and with the area of the intake port 2 of the cylinder head 1.

There are provided two valve bearing portions that oppose with each other at both side wall portions of the housing 5, in other words, at the housing left-right wall portions on both side of each valve accommodation space 25. The valve bearing portions are separated from each other by the second intake passage 12. The valve bearing portions define two supporting holes therein, respectively. Note that, two bearing members (for example, hollow cylindrical bearings) are fitted and supported in the inner periphery of the above supporting holes. In other words, the valve bearing portions of the housing 5 slidably support both end portions (two valve slide portions) of the intake air flow control valve 6 along the rotational axis of the intake air flow control valve 6 via the two bearings such that the end portions are rotatable in a rotating direction.

In the above structure, each of the two bearings is a hollow cylinder defining the slide hole therein, and is press fitted with a hole wall surface of the corresponding supporting hole of each of the two valve bearing portions of the housing 5. It should be noted that the above bearings may be omitted as required.

The intake air flow control valve 6 of each of the multiple valve units is integrally molded of a resin material to have a predetermined shape, for example. Also, each of the multiple intake air flow control valves 6 has a rotational center axis that is orthogonal to the axial direction (intake air flow direction) of the housing 5, and the control valve 6 rotates about the rotational center axis. The multiple intake air flow control valves 6 are bonded with each other by the single pin rod 8 in a state, where the pin rod 8 extends through the multiple control valves 6. Also, each of the multiple intake air flow control valves 6 is received in the corresponding housing 5 for being able to open and close the second intake passage 12 such that a cross-sectional area of the second intake passage 12 is changed. As above, the multiple intake air flow control valves 6 open and close the second intake passages 12 to control intake air flowing through the second intake passages 12.

Each of the multiple intake air flow control valves 6 includes the rotational shaft 7 and a valve main body. The rotational shaft 7 is configured to surround a shaft through hole 26, and to surround each valve supporting portion of the pin rod 8 in a circumferential direction. In other words, the rotational shaft 7 defines the shaft through hole 26 therein. The valve main body has a square plate shape or a rectangular plate shape and extends from the rotation center axis of the rotational shaft 7 toward one side in a radial direction that is perpendicular to the rotational axis.

Also, the pin rod 8 extends through the shaft through hole 26 along the rotational axis or in the center axial direction. Note that, the shaft through hole 26 of each intake air flow control valve 6 is configured to have a polygonal hole shape or a rectangular hole shape that corresponds to a cross-sectional shape (a rectangular shape) of the pin rod 8. In other words, the shaft through hole 26 is formed to have a similar hole shape that corresponds to a cross-sectional shape of the valve supporting portion of the pin rod 8. As a result, relative rotation between the rotational shaft 7 of the intake air flow control valve 6 and the pin rod 8 is controlled.

In each of the multiple intake air flow control valves 6, in a fully-closed state, where the plate valve main body is located at a position for closing the second passage 12, the rotational shaft 7 is positioned toward one side relative to the center section of the valve main body in the valve surface direction that is perpendicular to the thickness direction of the intake air flow control valve 6. In other words, the rotational shaft 7 is positioned closer to the lower side of the second intake passage 12 in the gravitational force direction in the valve fully-closed state. In the valve unit of the present embodiment, the intake air flow control valve 6 employs a cantilever valve, in which the rotational shaft 7 serving as the rotation center of the valve main body is positioned toward one side of the valve main body relative to the valve center section of the valve main body in the valve surface direction that is perpendicular to the thickness direction of the intake air flow control valve 6. In other words, the rotational shaft 7 is located on a side of the valve main body opposite to a free end of the valve main body. Thus, in the above cantilever valve configuration, the rotational shaft 7 is positioned at the lower side of the valve main body in FIG. 1B, for example.

Also, the rotational shaft 7 of each of the multiple intake air flow control valves 6, is rotatably received in the corresponding housing 5, or more specifically, in the supporting holes of the two valve bearing portion. Also, the rotational shaft 7 is configured to have a hollow cylindrical shape to surround the pin rod 8 in the peripheral direction. The two valve slide portions are provided at both the end portions of the intake air flow control valve 6 along the rotational axis (at both axial end portions of the rotational shaft 7) such that two valve slide portions are rotatably supported via the two bearings at the inner periphery of the two valve bearing portions of the housing 5 (at each hole wall surface of the corresponding supporting hole).

In the multiple valve units, each of the intake air flow control valves 6 is cut at one section (center section) of the valve top end surface, the top end surface being positioned in the top of the valve 6 in the gravitational force direction in the valve fully-closed state, where the multiple intake air flow control valves 6 are positioned to fully close the passages. Thus, each intake air flow control valve 6 has a rectangular opening 27 (notch, slit) for generating a drift flow, which is to be a tumble flow in the combustion chamber, to intake air supplied to the combustion chamber of each cylinder of the engine. Note that, the opening 27 may be alternatively omitted. Also, secondary openings (notches) may be additionally formed by cutting one section on each of the valve left-right sides of the intake air flow control valve 6, and the secondary opening may have a smaller opening area smaller than the opening 27, which serves as a primary opening.

In the above configuration, the pin rod 8 of the present embodiment is made of, for example, iron metal material. The pin rod 8 is a polygonal-cross-sectional shaft (rectangular steel shaft) having a cross section of a polygonal shape (for example, square shape), which cross section is perpendicular to the rotational axis. The pin rod 8 is received in the corresponding shaft through hole 26 formed in each of the multiple intake air flow control valves 6. The pin rod 8 bonds the rotational shafts 7 of the multiple intake air flow control valves 6 in a state, where the pin rod 8 extends through the rotational shafts 7 in a fixed relation. As a result, the pin rod 8 serves as the single drive shaft that bonds all of the intake air flow control valves 6 such that the intake air flow control valves 6 work together or are operable together. The pin rod 8 is press fitted with the hole wall surface of each shaft through hole 26 formed in each of the multiple intake air flow control valves 6.

Also, even if the pin rod 8 having the polygonal cross sectional shape is directly supported by each supporting hole of the two valve bearing portions of the housing 5, the pin rod 8 may not be smoothly rotated. Therefore, the pin rod 6 of the present embodiment is covered by each rotational shaft 7, and an outer periphery side of the pin rod 8 is supported by the inner peripheral surface of each of two bearings via the rotational shaft 7 such that the pin rod 8 is rotatably and pivotally supported. In other words, the outer periphery side of the pin rod 8 is supported by the hole wall surface of each slide hole.

Note that, in the valve unit of the present embodiment, there is provided predetermined slide clearances (clearances) between (a) the two valve slide portions (slide surfaces) of the rotational shaft 7 of the intake air flow control valve 6 and (b) the hole wall surfaces of the slide holes of the two bearings respectively such that the rotational shaft 7 of the intake air flow control valve 6 is smoothly slidable in each of the slide holes of the two bearings.

In the above, the ECU is configured to electrically control the electric motor, which drives the intake air flow control valves 6 via the pin rod 8. The ECU includes a known microcomputer, which includes a CPU, a storage apparatus, an input circuit (input portion), an output circuit (output portion), a power source circuit, and a timer. The CPU executes control processes and calculation processes, and the storage apparatus or a memory, such as ROM, RAM, stores control programs, control logics, or various data sets.

Also, when an ignition switch is energized or turned on (IG-ON), the ECU is configured to energize and control the electric motor for the intake air vortex flow generator and the electric motor for the throttle control device based on the control programs or the control logics stored in the memory. Also, in the above case, the ECU drives an ignition device (for example, an ignition coil, a spark plug) and a fuel injection system (for example, an electric fuel pump, an injector). Thus, the valve opening degree of the valve unit (TCV), the intake air amount, and the fuel injection quantity are controlled to match the corresponding control command values (control target values) during the operation of the engine.

Also, when the ignition switch is deenergized or turned off (IG-OFF), the ECU is configured to forcibly stop engine control including the ignition control and the fuel injection control, which control are executed based on the control programs or the control logics stored in the memory. Note that, when the engine is stopped or after the engine has been stopped, supply of the electric power to the electric motor for the intake air vortex flow generator is stopped, and thereby the valve unit (TCV) is controlled to fully open the passage, or the valve opening degree of the valve unit (TCV) becomes the fully-opened opening degree by the bias force of the return spring.

In the valve unit (TCV) of the present embodiment, a slope member 16 is fitted inside each housing 5. The slope member 16 has a block shape or a solid one-piece-body shape as shown in FIG. 1B, for example. The slope member 16 serves as an interior component that cancels a step 19 or a wall, which is provided between the intake manifold attachment surface 3 of the cylinder head 1 of the engine and the annular end surface 24 of the housing 5 of the valve unit (TCV). More specifically, the step 19 is provided between a lower surface of each intake port 2 of the engine in the gravitational force direction and another lower surface of each second intake passage 12 (valve accommodation space 25) of the housing 5 of the valve unit (TCV) in the gravitational force direction.

A bottom surface or a housing lower wall portion of the housing 5 of the present embodiment is provided with a fitting recess 31 that extends in the axial direction (intake air flow direction) of each second intake passage 12. The fitting recess 31 extends from the outlet portion of the housing 5 to reach a position of the housing lower wall portion below the rotational shaft 7 of the intake air flow control valve 6. Also, passage wall surfaces or the housing left-right wall portions of the housing 5 is provided with a pair of fitting recesses 32 that extends in the axial direction (intake air flow direction) of each second intake passage 12. The fitting recesses 32 extend from the outlet portion of the housing 5 to reach positions on the housing left-right wall portions below the rotational shaft 7 of the intake air flow control valve 6.

Each of multiple slope members 16 is integrally molded of a resin material to have a predetermined shape, for example. Each of the slope members 16 has a cross section of a right-angled triangle, which cross section is taken along a plane perpendicular to a transverse axis of the second intake passage 12. The slope member 16 has an inclined surface 34 that includes a hypotenuse of the right-angled triangle, and the inclined surface 34 smoothly connects the lower surface of each intake port 2 in the gravitational force direction with the lower surface of each second intake passage 12 (valve accommodation space 25) in the gravitational force direction. The inclined surface 34 of each of the multiple slope members 16 is angled such that the inclined surface 34 has one side toward the lower surface of each second intake passage 12, the one side being lower in elevation than the other side of the inclined surface 34 toward the lower surface of each intake port 2. Thus, the elevation (vertical position) of the inclined surface 34 becomes gradually higher from the lower surface of each second intake passage 12 to the lower surface of each intake port 2. Also, the inclined surface 34 of each of the multiple slope members 16 straightly extends from a starting point to an end point. In the above, the starting point is defined at a position on the bottom surface of the housing 5 lower than the rotational shaft 7 of the intake air flow control valve 6 in the gravitational force direction or a position on the bottom surface of the housing 5 below the intake air flow control valve 6. The end point is defined as a position near the outlet portion of the housing 5.

In other words, for example, the slope member 16 is provided in the second intake passage 12 of the housing 5 for gradually reducing a vertical dimension of the second intake passage 12 as a function of a position of the second intake passage 12 in the intake air flow direction. In the above, the vertical dimension of the intake passage 12 is measured generally vertically between opposing inner surfaces (up-down wall surfaces) of the second intake passage 12. Also, the inclined surface 34 of the slope member 16 radially inwardly extends from a position on the bottom surface of the second intake passage 12 below the intake air flow control valve 6 such that the inclined surface 34 is angled relative to an longitudinal axis of the second intake passage 12.

Also, the vertical dimension of the second intake passage 12 at a downstream end of the second intake passage 12 in the intake air flow direction is generally equal to a vertical dimension of the intake port 2. In the above, the vertical dimension of the intake port 2 is measured generally vertically between opposing inner walls (up-down wall surfaces) of the intake port 2. Also, the vertical dimension of the second intake passage 12 at a downstream end of the slope member 16 in the intake air flow direction is smaller than the vertical dimension of the second intake passage 12 at an upstream end of the slope member 16 in the intake air flow direction. As above, the slope member 16 provides a radially inwardly tapered surface (inclined surface) 34 at the bottom surface of the intake passage 12.

Each of the multiple slope members 16 has a fitting protrusion 35 at a lower end surface of the slope member 16, and the fitting protrusion 35 is fitted with the fitting recess 31 of the housing 6. Also, each of the multiple slope members 16 has a pair of fitting protrusions 36 on left-right side surfaces of the slope member 16, and the pair of fitting protrusions 36 are fitted with the pair of fitting recesses 32 of the housing 5, respectively.

The slope member 16 is inserted into the second intake passage 12, or more specifically into the valve accommodation space 25, from the outlet portion of the housing 5 such that each of the fitting protrusions 35, 36 of the slope member 16 is fitted with and supported by the corresponding fitting recess 31, 32 of the housing 5.

Also, each of the multiple slope members 16 includes a flat surface 37 provided on a plane, on which the annular end surface 24 of the housing 5 is provided. Also, the flat surface 37 faces the intake manifold attachment surface 3 of the cylinder head 1 with a predetermined clearance between the flat surface 37 and the intake manifold attachment surface 3. Note that, the flat surface 37 of each of the multiple slope members 16 may contact the intake manifold attachment surface 3 of the cylinder head 1 or the step 19 alternatively.

The slope member 16 may be supported inside the housing 5 in a fixed relation, and alternatively the slope member 16 may be fitted inside the housing 5 in a fixed relation. Also, the slope member 16 may be elastically supported inside the housing 5. As above, by fitting the fitting protrusion 35, 36 of the slope member 16 with the fitting recess 31, 32 of the housing 5, the slope member 16 is located at a position inside the housing 5.

After assembling the multiple valve units, each of which receives the slope member 16, into the housing receiving chambers 13 of the intake manifold 4, the intake manifold 4 is air-tightly connected with the intake manifold attachment surface 3 of the cylinder head 1. As a result, as shown in FIG. 1B, the slope member 16 is provided in a space defined between the intake manifold attachment surface 3 (the step 19) of the cylinder head 1 and the rotational shaft 7 of the intake air flow control valve 6. In other words, the slope member 16 is provided in the valve accommodation space 25 on a side of the rotational shaft 7 toward the cylinder head 1.

### Operation of First Embodiment

The operation of the intake control device for the internal combustion engine (the intake air vortex flow generator) of the present embodiment will be described with reference to FIGS. 1A and 1B.

When the ignition switch is energized or turned on (IG-ON), the ECU energizes and controls the electric motor for the throttle control device, and the ECU drives the ignition device (for example, the ignition coil, the spark plug), and the fuel injection system (for example, the electric fuel pump, the injector). Thus, the engine is operated. In the above, when the operation of a specific cylinder of the engine is shifted from an exhaust stroke to an intake stroke, a vacuum pressure in the combustion chamber of the cylinder of the interest, which pressure is lower than the atmospheric pressure, is increased in accordance with the descend of the piston, and the air-fuel mixture is suctioned to the combustion chamber through the intake port 2, which is opened. As above, in the intake stroke, the intake valve opens the intake port 2 and the piston descends.

Also, when the engine is heated and thereby the more amount of suctioned intake air (more intake air amount) is required, in other words, when the engine is normally operated, the ECU controls the supply of the electric power to the electric motor of an intake air vortex flow generator, or the ECU energizes the electric motor, for example. In the above, by using the driving force of the electric motor, the multiple intake air flow control valves 6 and the pin rod 8 are driven or actuated in the valve opening direction. Thus, the multiple intake air flow control valves 6 are opened. In other words, the multiple intake air flow control valves 6 and the pin rod 8 are operated such that the multiple intake air flow control valves 6 are positioned at the fully-opened position for fully opening the passages 12.

In the above case, intake air flows from the first intake passage 11 of the intake manifold 4 into the second intake passage 12 formed in the housing 5 via the inlet portion of the housing 5. Then, the intake air passes straight through the second intake passage 12, and is introduced into the intake port 2 mounted on the cylinder head 1 through the outlet portion of the housing 5. Then, the intake air flow, which passes through the intake port 2, is supplied into the combustion chamber through the intake air valve port of the intake port 2. At the above case, the intake air vortex flow in the axial direction (tumble flow) is not generated in the combustion chamber.

In contrast when the engine is cooled, and thereby the less amount of suctioned intake air (less intake air amount) is required, in other words, when the engine is started or idled, the ECU controls the supply of the electric power to the electric motor of intake air vortex flow generator, or the ECU energizes the electric motor, for example. In the above case, by using the driving force of the electric motor, the multiple intake air flow control valves 6 and the pin rod 8 are driven in the valve closing direction. Thus, the multiple intake air flow control valves 6 are closed. In other words, the multiple intake air flow control valves 6 are controlled such that the valve opening degree of the valve unit (TCV) becomes the fully closed opening degree, or such that the valves 6 are located at the fully-closed position for fully closing the passages 12.

In the above case, most of the intake air, which flows from the first intake passage 11 into the second intake passage 12 via the inlet portion of the housing 5, flows through a clearance (the opening 27) between the valve top end surface of the intake airflow control valve 6 and the housing upper wall portion of the housing 5. Then, the intake air is introduced from the outlet portion of the housing 5 into an upper layer portion of each intake port 2, and then the intake air flows along a top wall surface at the upper layer portion of the intake port 2. Then, the intake air flow, which flows along the top wall surface at the upper layer portion of the intake port 2, is supplied the combustion chamber from the intake air valve port of the intake port 2. In the above case, the tumble flow is generated in the combustion chamber of each cylinder of the engine, and thereby when the engine is started or idled, an efficiency of combustion in the combustion chamber is improved. As a result, fuel economy and emission (for example, HC reduction effect) are improved.

### Advantages of First Embodiment

The intake control device (intake air vortex flow generator) for the internal combustion engine of the present embodiment employs the cantilever intake air flow control valve 6 as the valve element of valve unit (TCV).

Also, the multiple valve units (TCV) have the valves such that valve surfaces or flat surfaces of the valves are arranged to extend in the intake air flow direction when the valves are in the fully-opened position. Furthermore, the intake air flow control valve 6 is received in the valve accommodation space 25 of the housing 5 such that the intake air flow control valve 6 is limited from projecting in the main passage of the second intake passage 12 when the valve is located at the fully-opened position. As a result, the intake air resistance at the valve full open state is reduced.

Also, a part or a center section of the valve top end surface of the intake air flow control valve 6 is cut. Note that the top end surface is positioned at the top end in the gravitational force direction (vertical direction) in a state, where the valve is at the full-closed position. Thus, each intake air flow control valve 6 has the rectangular opening 27 or the rectangular notch for generating a drift flow, which is to be a tumble flow in the combustion chamber, to the intake air supplied to the combustion chamber of each cylinder of the engine.

Also, in the intake control device having the valve accommodation space 25 at the lower portion of each second intake passage 12 of the housing 5 in the gravitational force direction, the step 19 is formed between the intake manifold attachment surface 3 of the cylinder head 1 and the annular end surface 24 of the housing 5. More specifically, the step 19 is provided between the lower surface of each intake port 2 of the engine and the lower surface of each second intake passage 12 (valve accommodation space 25) of the housing 5 of the valve unit (TCV) in the gravitational force direction.

In a conventional structure, when fuel is blown backward, fuel may fall into and stay at the lower surface of the valve accommodation space 25 of the housing 6 or the lower part of the housing 5 in the gravitational force direction. In the above, the fuel, which stays at the lower part of the housing 5, is blocked by the step 19, and thereby a large amount of fuel may be accumulated at the lower part of the housing 5 in the conventional structure.

However, in the valve unit (TCV) of the present embodiment, the slope member 16, which is provided in the valve accommodation space 25 of the housing 5, cancels the step 19 provided between the intake manifold attachment surface 3 of the cylinder head 1 and the annular end surface 24 of the housing 5. In the above, more specifically, the slope member 16 is provided at the lower part of each second intake passage 12 of the housing 5 in the gravitational force direction. As a result, fuel, which otherwise stays or has been accumulated in the lower part of the housing 5, gets over the step 19 through the inclined surface 34 of the slope member 16 to easily return to the intake port 2 of the engine. As above, the slope member 16 is configured to allow the fuel accumulated in the housing 5 to get over or flow around the step 19.

When each intake air flow control valve 6 is at the full-closed position for closing the passage, a part of the intake air, which flows from the first intake passage 11 to the second intake passage 12, flows through the clearance defined between the step 10 of the intake manifold 4 and the rotational shaft 7 of the intake air flow control valve 6. Then, the part of the intake air flows around the rotational shaft 7 along the lower surface of the second intake passage 12 (the bottom surface of the housing 5) in the gravitational force direction. Then, intake air flow is generated, which flows from the clearance defined between the lower surface of the second intake passage 12 (the bottom surface of the housing 5) and the rotational shaft 7 of the intake air flow control valve 6. Then, the generated intake air flow flows into the intake port 2 of the engine along the inclined surface 34 of the slope member 16.

As above, a bypass passage is defined between the slope member 16 and the rotational shaft 7 of the intake air flow control valve 6, and the bypass passage allows intake air to flow around the rotational shaft 7 of the intake air flow control valve 6 when the intake air flow control valve 6 is located at the fully-closed position for closing the second intake passage 12, for example.

When each intake air flow control valve 6 is at the full-closed position for closing the passage, intake air flow, which thus flows along the inclined surface 34 of the slope member 10, is used to blow the accumulated fuel, which has been accumulated in the lower part of the housing 5, toward the intake port of each cylinder of the engine. Thus, a large amount of fuel is limited from being accumulated in the lower part of the housing 5.

Accordingly, the large amount of fuel accumulated in the lower part of the housing 5 is limited from flowing into the combustion chamber of each cylinder of the engine in one stroke. As a result, the air-fuel ratio in the combustion chamber of each cylinder of the engine is limited from becoming considerably richer or excessively richer, and thereby, the exhaust gas purification performance or an emission is limited from deteriorating.

Also, in the valve unit (TCV) of the present embodiment, the slope member 16 is provided between the rotational shaft 7 of the intake air flow control valve 6 and the step 19. Due to the above configuration, the step 19 limits the slope member 16 from being displaced toward the intake port of each cylinder of the engine and toward the combustion chamber. As a result, the slope member 16 is limited from falling apart from the housing 5, and thereby the slope member 16 is limited from falling into the intake port 2 of the engine and into the combustion chamber. Thus, the slope member 16 is limited from interfering with movable members, such as the intake valve, the piston, of the engine. As a result, the engine is limited from being damaged.

Also, in the valve unit (TCV) of the present embodiment, the cantilever valve is employed as the intake air flow control valve 6. Due to the above configuration, when the intake air flow control valve 6 is at the fully-opened position, or when the opening degree of the intake air flow control valve 6 corresponds to the fully-opened opening degree for fully opening the second intake passage 12 of the housing 5, the intake air flow, which flows into the housing 5 or into the second intake passage 12, flows through the housing 5 (second intake passage 12) without being blocked by the valve main body and the rotational shaft 7 of the intake air flow control valve 6. In other words, intake air flows which flows into the housing 5 (second intake passage 12), flows straight inside the housing 5 or straight through the second intake passage 12, and is introduced into the combustion chamber of each cylinder of the engine from the housing 5 (the second intake passage 12). Accordingly, the intake air resistance in a state, where the valve is at the fully-opened position, is able to be reduced.

### Second Embodiment

FIGS. 2A and 2B show the second embodiment of the present invention, and specifically, FIG. 2A is a front view showing a valve unit (cartridge), and FIG. 2B is a diagram illustrating an intake control device for the internal combustion engine.

In the valve unit (TCV) of the present embodiment, the plate-shaped slope member 17 is fitted inside each housing 5. The slope member 17 serves as the interior component for canceling the step 19 shown in FIG. 2B.

Note that, the bottom surface or the housing lower wall portion of the housing 5 of the present embodiment is provided with the fitting recess 41 that extends straightly in the axial direction (intake air flow direction) of each second intake passage 12 from the outlet portion of the housing 5 to reach a position below the rotational shaft 7 of the intake air flow control valve 6. Also, the pair of fitting recesses 42 are provided at the lower portion of the second intake passage 12 in the gravitational force direction. In other words, the fitting recesses 42 are provided in the passage wall surfaces or the housing left-right wall portion of the housing 5 at the lower side thereof. There is formed a pair of engaging portions 43 above these fitting recesses 42. The engaging portions 43 are steps formed between a thick wall portion and a thin wall portion in the housing left-right wall portions of the housing 5.

Each of the multiple slope members 17 is integrally formed of a metal material, such as spring steel, to have a predetermined shape. Each of the slope members 17 has a cross section of a V shape, and includes an inclined surface 44 that smoothly connects the lower surface of each intake port 2 with the lower surface of each second intake passage 12 (valve accommodation space 25) in the gravitational force direction. The inclined surface 44 of each of the multiple slope members 17 is angled such that the inclined surface 44 has an elevation that gradually becomes higher from the lower surface of each second intake passage 12 to the lower surface of each intake port 2. Also, the inclined surface 44 of each of the multiple slope members 17 extends straightly from a starting point to an end point. The starting point is defined at a position lower than the rotational shaft 7 of the intake air flow control valve 6 in the gravitational force direction or a position below the intake air flow control valve 6. The end point is defined near the outlet portion of the housing 5.

Each of the multiple slope members 17 has a base portion 45 at a lower end surface of the slope member 17, and the base portion 45 is fitted with the fitting recess 41 of the housing 5. Also, each of the multiple slope members 17 includes a pair of engaged portions 46 at the left-right side surfaces of the slope member 17, and each engaged portion 46 is press fitted into the corresponding one of the pair of engaging portions 43 of the housing 5. Each of the engaged portions 46 is made of a leaf spring for being resiliently deformable.

By inserting the slope member 17 into the second intake passage 12 from the outlet portion of the housing 5, or more specifically, into the valve accommodation space 25, the base portion 45 of the slope member 17 is fitted with and supported by the fitting recess 41 of the housing 5. Also, the pair of engaged portions 46 of the slope member 17 are press fitted with and supported by the pair of engaging portions 43 of the housing 5 respectively.

As above, the intake air vortex flow generator or the valve unit (TCV) of the present embodiment is capable of achieving the similar advantages similar to the advantages achieved by the first embodiment.

As above, by press fitting the engaged portion 46 of the slope member 17 into the engaging portion 43 of the housing 5, the slope member 17 is located at a position in the housing 5.

### [Modification]

In the present embodiment, the present invention is applied to the intake control device for the internal combustion engine having the intake air vortex flow generator. However, the present invention may be applied to an intake air flow control apparatus (the throttle control device) for the internal combustion engine, which apparatus is capable of controlling the amount of intake air auctioned into the combustion chamber of each cylinder of the internal combustion engine. Also, the present invention may be applied to a variable intake control device for the internal combustion engine, which apparatus includes intake air adjustable valve for changing a passage length of the intake passage or the passage cross-sectional area.

In the present embodiment, the intake air vortex flow generator is configured to generate the intake air vortex flow in the axial direction (tumble flow) in order to enhance the combustion of the air-fuel mixture in the combustion chamber of each cylinder of the engine. However, the intake air vortex flow generator may be alternatively configured to generate an intake air vortex flow in a lateral direction (swirl flow) in order to enhance the combustion of the air-fuel mixture in the combustion chamber of each cylinder of the engine. Also, the intake air vortex flow generator may be further alternatively configured to generate a squish vortex in order to enhance the combustion in the engine.

In the present embodiment, the valve drive device (actuator), which drives the rotational shaft 7 of the intake air flow control valve 6, employs an electric actuator having the electric motor. However, an alternative actuator, which drives the rotational shaft of the valve, may be a vacuum operated actuator having an electromagnetic or electric vacuum control valve. Also, the alternative actuator may employ an electromagnetic actuator that includes an electromagnet, such as a coil, and a moving core (an armature).

Also, in the present embodiment, the TCV serves as the intake air control valve, which includes a valve provided in the intake passage formed in the intake air induction duct, and which controls suctioned air (intake air) suctioned into the combustion chamber of the engine. However, instead of the TCV of the present embodiment, an intake air flow control valve, which includes a throttle valve provided in the intake passage defined in the throttle body, may be employed. The intake air flow control valve controls an amount of intake air (intake air amount) suctioned into the combustion chamber of the engine. Also, alternatively, another intake air flow control valve, which includes an idle rotation speed control valve provided in the intake passage defined in the housing, may be employed. The above intake air flow control valve controls an amount of intake air (intake air amount) that bypasses the throttle valve.

Also, instead of the intake air flow control valve, such as TCV, or instead of the intake air flow control valve, an intake passage on-off valve, an intake passage switch valve, or an intake air pressure control valve may be employed as the intake air control valve having the valve. Also, the intake air control valve of the present invention may be applied to the intake air flow control valve (for example, a tumble flow control valve, a swirl flow control valve) and also may applied to an intake air adjustable valve that changes the passage length of the intake passage or the passage cross-sectional area. Also, the engine may be a diesel engine. Also, the engine is not limited to a multiple cylinder engine, but may be a single cylinder engine.

Also, the valve is not limited to the multiple integral intake air flow control valve assembly having multiple valve units, but may be a single cantilever valve unit or a single double-flap valve unit provided that the valve is received in the housing for freely opening and closing the passage therein. In the above, the double-flap valve unit includes a rotational shaft and two flaps or two valve elements that extend from the rotational shaft in opposite radial directions of the rotational shaft.

Also, in the present embodiment, the intake air flow control valve 6 has a square front shape or a rectangular front shape. However, the intake air flow control valve 6 may alternatively have a round front shape, an oval front shape, a rectangular round shape, or a polygonal front shape. In the above alternative case, the cross-sectional shape of the intake passage in the housing (tubular portion) of the intake air induction duct is configured to have the shape that corresponds to the front shape of the intake air flow control valve 6.

In the present embodiment, the housing 5 of the valve unit is a separate part or a separate component separate from the resin slope member 16 or the metal plate slope member 17. However, the resin slope member 16 or the metal plate slope member 17 may alternatively be formed integrally with the housing 5 of the valve unit. For example, the slope member 16, 17 may be molded of a resin integrally with the housing 5, or may be insert molded with the housing 5.

Additional advantages and modifications will readily occur to those skilled in the art. The invention in its broader terms is therefore not limited to the specific details, representative apparatus, and illustrative examples shown and described.

What is claimed is:

1. An intake control device for an internal combustion engine comprising:
an intake air induction duct that includes a bonding surface that is bonded with an attachment surface of the internal combustion engine, the intake air induction duct defining therein a receiving chamber that opens at the bonding surface;
a housing that is received in the receiving chamber of the intake air induction duct, the housing defining therein an intake passage that is communicated with an intake port of the internal combustion engine;
a valve that is received in the housing for opening and closing the intake passage of the housing; and
a slope member that cancels a step provided between the intake port of the internal combustion engine and the intake passage of the housing.

2. The intake control device according to claim 1, wherein:
the housing has an annular end surface at a downstream side of the housing in an intake air flow direction, the annular end surface facing the attachment surface of the internal combustion engine, the annular end surface being spaced from the attachment surface by a predetermined clearance; and
the step is provided between the attachment surface of the internal combustion engine and the annular end surface of the housing.

3. The intake control device according to claim 1, wherein:
the intake port of the internal combustion engine opens at the attachment surface of the internal combustion engine; and
the step is at least provided between a lower surface of the intake port of the internal combustion engine in a gravitational force direction and a lower surface of the intake passage of the housing in the gravitational force direction.

4. The intake control device according to claim 3, wherein:
the slope member includes an inclined surface that smoothly connects the lower surface of the intake passage of the housing with the lower surface of the intake port of the internal combustion engine.

5. The intake control device according to claim 3, wherein:
the slope member includes an inclined surface that is angled such that the inclined surface has an elevation that gradually becomes higher from the lower surface of the intake passage of the housing to the lower surface of the intake pod of the internal combustion engine.

6. The intake control device according to claim 1, wherein:
the housing includes an outlet portion, at which a downstream end of the intake passage of the housing in an intake air flow direction opens;
the slope member includes an inclined surface that extends from a starting point to an end point;
the starting point is defined at a position lower than the valve in a gravitational force direction; and
the end point is defined near the outlet portion.

7. The intake control device according to claim 1, wherein the slope member is provided inside the housing.

8. The intake control device according to claim 1, wherein:
the housing includes a fitting recess at a lower portion of the intake passage of the housing in a gravitational force direction; and
the slope member includes a fitting protrusion that is fitted with the fitting recess.

9. The intake control device according to claim 1, wherein:
the housing includes an engaging portion at a lower portion of the intake passage of the housing in a gravitational force direction; and
the slope member includes an engaged portion that is press fitted into the engaging portion.

10. The intake control device according to claim 1, wherein:
the housing defines a valve accommodation space at a lower portion of the intake passage in a gravitational force direction, the valve accommodation space accommodating the valve when the valve is located at a fully-opened position for fully opening the intake passage.

11. The intake control device according to claim 1, wherein:
the valve is a cantilever valve having a rotational shaft that is displaced from a center of the valve toward one end of the valve, the rotational shaft serving as a rotation center, about which the cantilever valve rotates.

12. The intake control device according to claim 4, wherein the inclined surface is angled such that the inclined surface has an elevation that gradually becomes higher from the lower surface of the intake passage of the housing to the lower surface of the intake port of the internal combustion engine.

13. An intake control device for an internal combustion engine having an intake port and an attachment surface, the intake control device comprising:
an intake air induction duct that includes a bonding surface that is bonded with the attachment surface of the internal combustion engine, the intake air induction duct defining therein a receiving chamber that opens at the bonding surface;
a housing that is received in the receiving chamber of the intake air induction duct, the housing defining therein an intake passage that is communicated with the intake port of the internal combustion engine;
a valve that is received in the housing for opening and closing the intake passage of the housing; and
a slope member that is provided in the intake passage of the housing for gradually reducing a vertical dimension of the intake passage as a function of a position of the intake passage in an intake air flow direction, the vertical dimension of the intake passage being measured generally vertically between opposing inner surfaces of the intake passage, wherein:
the slope member is provided at a position to define a bypass passage between the slope member and the valve, the bypass passage allowing intake air to flow around the valve when the valve is located at a fully-closed position for closing the intake passage.

14. The intake control device according to claim 13, wherein:
the slope member has an inclined surface that inwardly extends from a position on a bottom surface of the intake passage below the valve such that the inclined surface is angled relative to an longitudinal axis of the intake passage.

15. The intake control device according to claim 13, wherein:
the vertical dimension of the intake passage at a downstream end of the intake passage in the intake air flow direction is generally equal to a vertical dimension of the intake port, the vertical dimension of the intake port being measured generally vertically between opposing inner walls of the intake port.

16. The intake control device according to claim 13, wherein:
the vertical dimension of the intake passage at a downstream end of the slope member in the intake air flow direction is smaller than the vertical dimension of the intake passage at an upstream end of the slope member in the intake air flow direction.

17. The intake control device according to claim 13, wherein:
the slope member provides a radially inwardly tapered surface at a bottom surface of the intake passage.
